(19) United States
(12) Patent Application Publication
(10) Pub. No.: US 2024/0367654 A1
(43) Pub. Date: Nov. 7, 2024

(54) A SYSTEM FOR PREVENTING THE PHENOMENON OF AQUAPLANING IN A MOTOR-VEHICLE, AND RELATED METHOD

(71) Applicant: Easy Rain I.S.p.A., Milano (MI) (IT)

(72) Inventor: Giovanni BLANDINA, Milano (MI) (IT)

(21) Appl. No.: 18/574,827

(22) PCT Filed: Jun. 27, 2022
(86) PCT No.: PCT/IB2022/055945

§ 371 Date: Dec. 28, 2023

(30) Foreign Application Priority Data
Jul. 2, 2021 (IT) 102021000017612

(51) Int. Cl. B60W 30/18; B60B 39/02; B60W 30/02; B60W 50/14

(52) U.S. Cl. CPC B60W 30/18172; B60B 39/025; B60W 30/02; B60W 50/14; B60W 2420/403; B60W 2555/20; B60W 2556/45; B60W 2556/65; B60W 2720/10

(57) ABSTRACT

An anti-aquaplaning system for a motor-vehicle, includes control unit configured to assist a driver to avoid aquaplaning. The control unit is programmed for: receiving real time signals detected by automated driving assistance devices and a data transmission and receiving unit, integrating the received signals to generate an output signal indicative of a risk of aquaplaning, if said output signal exceeds a predetermined value of a minimum risk condition, generating a warning for the driver to inform him preventively of the risk of encountering a water layer which could lead to a lifting and/or slipping condition of the wheels on the wet road surface, in such a way that said control unit alerts the driver prior to contact of the wheels with the water layer on the road surface in such a quantity as to no longer ensure an adequate grip between the wheels and the road surface.

### FIELD OF THE INVENTION AND KNOWN ART

The present invention refers to a system and a related method for preventing the phenomenon of aquaplaning in a motor-vehicle.

As it is well known, aquaplaning is a phenomenon which may take place when a moving motor-vehicle encounters a water layer extended on the road surface, in such a quantity as to no longer ensure an adequate grip between the wheels of the motor-vehicle and the road surface. As a consequence, in such conditions, a wheel lifting and/or slipping condition occurs on the wet road surface, with a consequent loss of grip of the tires.

In order to reduce the risks deriving from said phenomenon, a number of different solutions have already been developed and proposed, i.a. as described in the Italian Patent Application n. 102014902296915 in the name of the same Applicant. The solution described in said document envisages the use of injector means, associated to at least one wheel of the motor-vehicle, which are adapted to generate a jet of high-pressure fluid onto the wet road surface. Said system is configured to act when such a condition arises as to require the emission of said jet of high-pressure fluid onto the wet road surface.

One of the main problems of the known solutions consists in generating anti-aquaplaning actions reactively, i.e., when the motor-vehicle is already located on a water layer adapted to cause a loss of grip of the tires.

### OBJECT OF THE INVENTION

The present invention is based on the desire of implementing a system, of the kind mentioned in the foregoing, which may act prior to the contact of the motor-vehicle tires with a water layer, which extends in such an amount as to generate an aquaplaning phenomenon, in such a way as to increase the safety level in comparison with the known solutions.

A further object of the invention consists in implementing such a system with relatively easy means, without significantly impacting on the overall weight of the motor-vehicle and on the development costs.

A still further object of the invention consists in implementing a system as mentioned above which exhibits high flexibility, being easily adaptable to different motor-vehicle architectures.

In order to achieve one or more of said goals, the invention concerns an anti-aquaplaning system for a motor-vehicle, comprising:
a data transmission and receiving unit, connectable to a cellular telephone network infrastructure, provided to transmit and receive a plurality of information,
at least one automated driving assistance device, provided to detect the dynamic conditions of the motor-vehicle and/or of the environment in which the motor-vehicle is located, in order to assist the driver for different driving functions and to increase the safety level,
an electronic control unit, configured to assist the driver to avoid an aquaplaning phenomenon, the electronic control unit being programmed for:
receiving in real time a plurality of signals detected by means of the automated driving assistance devices and by means of the data transmission and receiving unit,
integrating said signals to generate an output signal indicative of the risk of aquaplaning,
if said output signal exceeds a predetermined value corresponding to a minimum risk condition, generating a warning for the driver so as to inform him preventively of the possible risk of encountering a water layer which could lead to a lifting and/or slipping condition of the wheels on the wet road surface,
in such a way that said electronic control unit is configured to alert the driver prior to the contact of the motor-vehicle tires with a water layer extended on the road surface in such a quantity as to no longer ensure an adequate grip between the wheels of the motor-vehicle and the road surface.

Another object of the invention consists in the method implemented by means of the system described in the foregoing.

Further features of the inventions are stated in the annexed dependent claims.

### BRIEF DESCRIPTION OF THE DRAWINGS

The present invention will now be described in detail with reference to the annexed drawings, which are provided by way of non-limiting example only, and wherein:

FIG. 1 is a schematic perspective view showing a preferred embodiment of the system according to the invention,

FIG. 2 is a diagram showing the operation of the system according to the invention, and

FIG. 3 is a schematic view showing further components of another embodiment of the system according to the invention.

### DETAILED DESCRIPTION

In the following description, various specific details are given to provide a thorough understanding of examples of one or more embodiments. The embodiments may be practiced without one or more of the specific details, or with other methods, components, materials etc. In other instances, well-known structures, materials or operations are not shown or described in detail in order to avoid obscuring various aspects of the embodiments. Reference throughout this specification to “one embodiment” or “an embodiment” means that a particular feature, structure or characteristic described in connection to the embodiment is included in at least one embodiment. Thus, the possible appearances of phrases such as “in one embodiment” or “in an embodiment” in various places throughout this specification are not necessarily all referred to the same embodiment. Furthermore, particular features, structures or characteristics may be combined in any suitable manner in one or more embodiments, and/or may be associated with the embodiment in a manner other than illustrated, so that, e.g., a feature exemplified herein with reference to a Figure may be applied to one or more embodiments exemplified in another Figure.

The headings provided herein are for convenience only, and therefore do not interpret the extent of protection or scope of the embodiments.

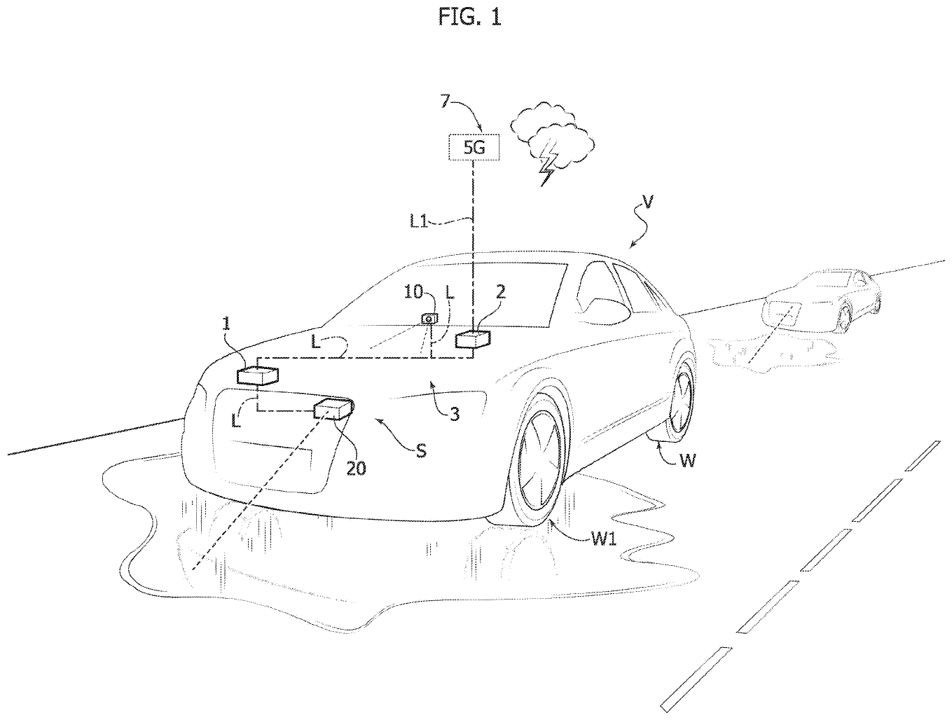

In FIG. 1, reference V globally denotes a motor-vehicle including a system S for preventing the phenomenon of aquaplaning according to the present invention.

According to the invention, system S comprises:
a data transmission and receiving unit 2, connectable to a cellular telephone network infrastructure 7, provided to transmit and receive a plurality of information,
automated driving assistance devices—globally denoted with reference 3—provided to detect the dynamic conditions of the motor-vehicle V and/or of the environment in which the motor-vehicle V is located, in order to assist the driver for different driving functions and to increase the safety level,
an electronic control unit 1, which is configured to prevent a phenomenon of aquaplaning and which is operatively connected, by means of communication lines L, to the data transmission and receiving unit 2 and to the automated driving assistance devices 3.

According to advantageous features of the invention, which will be detailed in the following, the electronic control unit 1 is configured to warn the driver about a risk of aquaplaning, prior to the contact of the tires W of the motor-vehicle V with a water layer extended on the road surface in such a quantity as to no longer ensure an adequate grip between the wheels W of the motor-vehicle V and the road surface.

In one or more embodiments, the electronic control unit 1 is an electronic module which controls the power train of the motor-vehicle V.

The data transmission and receiving unit 2 is configured to communicate with network 7—by means of communication lines L1—for example on the basis of a 5G mobile network technology, in such a way as to:
transmit a plurality of information to a central server and/or to other vehicles located on the same road network, and
receive a plurality of information from a central server and from other vehicles located on the same road network.

In one or more embodiments, the data transmission and receiving unit 2 is connected to a cellular telephone network infrastructure 7, to transmit and/or receive data relating to the local weather conditions of the area where the motor-vehicle V is located.

In one or more embodiments, the data transmission and receiving unit 2 is connected to a cellular telephone network infrastructure 7, to transmit and/or receive data relating to the local weather conditions which the motor-vehicle V may encounter along a route set on a GPS navigation device onboard the motor-vehicle V.

In one or more embodiments, the data transmission and receiving unit 2 is connected to a cellular telephone network infrastructure 7, to receive data relating to the conditions of the road surface deriving from mapped information available in the central server or from detections by systems installed on other vehicles which have passed through the same area where the motor-vehicle V is located.

In one or more embodiments, the data transmission and receiving unit 2 is connected to a cellular telephone network infrastructure 7, to transmit data relating to the conditions of the road surface deriving from detections performed by a system installed onboard the motor-vehicle V and configured to detect such conditions (e.g., a camera applied on the windshield of the motor-vehicle V).

In one or more embodiments, the data transmission and receiving unit 2 is connected to a cellular telephone network infrastructure 7, to transmit a notification of intervention occurred by electronic stability control systems mounted onboard the motor-vehicle V, and/or receive such a notification from other vehicles which have passed through the same area.

In one or more embodiments, the data transmission and receiving unit 2 is connected to a cellular telephone network infrastructure 7, to receive data relating to the dangerousness level of the route of interest, through accidents statistics available in the central server. As stated in the foregoing, system S comprises at least one automated driving assistance device 3, provided to detect the dynamic conditions of the motor-vehicle V and/or of the environment in which the motor-vehicle V is located, in such a way as to assist the driver for different driving functions and increase the safety level. As will be apparent from the description in the following, the electronic control unit 1 is programmed for receiving input signals not only from the data transmission and receiving unit 2, but also from said at least one automated driving assistance device, in such a way as to process an output signal which is particularly reliable, because it is generated from the combination of a plurality of signals which detect the conditions outside the motor-vehicle according to various parameters (e.g., weather conditions, road traffic conditions, presence of water layers, etc.).

In one or more embodiments of the invention, the automated driving assistance devices 3 may include a camera 10, which is applicable on the windshield of the motor-vehicle V and/or in proximity of the front bumper and which is arranged to record the events taking place outside the motor-vehicle V in the direction in which the camera is directed.

In one or more embodiments of the invention, the automated driving assistance devices 3 may comprise a detection device 20 (which may be a radar or a lidar), configured to emit receive radio waves or electromagnetic waves, in order to scan and detect the position of objects scanned outside the motor-vehicle V, such as, e.g., water layers extended on the road surface.

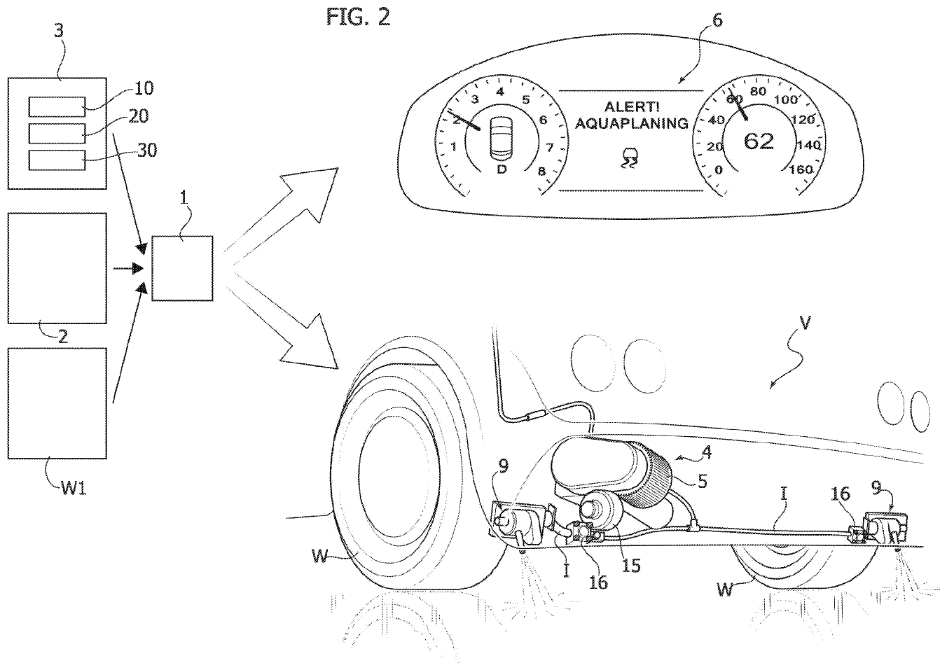

In one or more embodiments of the invention, the automated driving assistance devices 3 may comprise a road traffic data communication device 30 (schematically shown in FIG. 2), configured to send and receive information about the road traffic to/from other motor-vehicles.

In one or more embodiments of the invention, the automated driving assistance devices 3 may comprise a vehicle rain sensor detecting the presence of water, configured to detect the frequency of the rain drops and to automatically actuate the windscreen wipers at a certain speed which depends on said frequency.

Thanks to the features described in the foregoing of the data transmission and receiving unit 2, which is connectable to a cellular telephone network infrastructure 7, and of the automated driving assistance devices 3, the electronic control unit 1 is programmed for:
receiving in real time a plurality of signals detected by the automated driving assistance devices 3 and by the data transmission and receiving unit 2;
processing the received signals to generate an output signal indicative of the risk of aquaplaning; and
if the output signal exceeds a predetermined value corresponding to a minimum risk condition, generating a warning for the driver, so as to inform him—prior to the contact between the tires and an extended water layer—of the possible risk of encountering a water layer which may cause a lifting and/or slipping condition of the wheels on the road surface.

Thanks to said features, the electronic control unit 1 is configured to process an output signal which is particularly reliable, because it is generated from the combination of a plurality of signals which detect the conditions outside the motor-vehicle according to various parameters (weather conditions, road traffic conditions, presence of water layers, etc.). Therefore, the system S according to the invention enables preventing a phenomenon of aquaplaning without the need of generating an anti-aquaplaning action reactively, after the tires of the motor-vehicle have already made contact with the extended water layer.

It will be remarked that, according to the invention, the electronic control unit 1 is configured to store a predetermined risk scale indicative of the risk of aquaplaning, based on multiple combinations of different parameters (weather conditions, road surface conditions, intervention of electronic stability control systems, etc.), in such a way as to compare in real time such a scale with the output signal processed from the information received by means of unit 2, and ultimately to act proportionally to the detected information, so as to prevent aquaplaning in different scenarios.

As shown in FIG. 2, in one or more embodiments system S is configured to generate a warning on an instrument panel 6 of the motor-vehicle V whereon system S is mounted.

In one or more embodiments of the invention, the electronic control unit 1 is configured to reduce the speed of the motor-vehicle V if the output signal exceeds a predetermined value corresponding to an intermediate risk condition.

According to a further feature of the invention, system S may moreover comprise one or more the sensorized tires W1, provided to detect and transmit information relating to the road surface and to the forces exchanged between the tires and the road surface. In such a case, the electronic control unit 1 is moreover programmed for receiving the signals detected by the sensorized tires W1, and for processing such signals together with the signals received by the data transmission and receiving unit 2 and from the automated driving assistance devices 3.

According to a further embodiment, system S may moreover comprise further components, provided to generate an anti-aquaplaning action reactively when the aquaplaning phenomenon is occurring, so as to further increase the safety level. In this embodiment, if the output signal processed by the electronic unit 1 exceeds a predetermined level corresponding to a high risk condition, the electronic control unit 1 is configured to start activating such further components.

The components configured to generate an anti-aquaplaning action reactively may include injector means 9 configured to direct, onto the wet road surface, a jet of high-pressure fluid, so as to remove the water layer stationing on said surface. The injector means 9 are associated to at least one wheel of the motor-vehicle V, preferably to the front of the tread of the front wheels (FIG. 2).

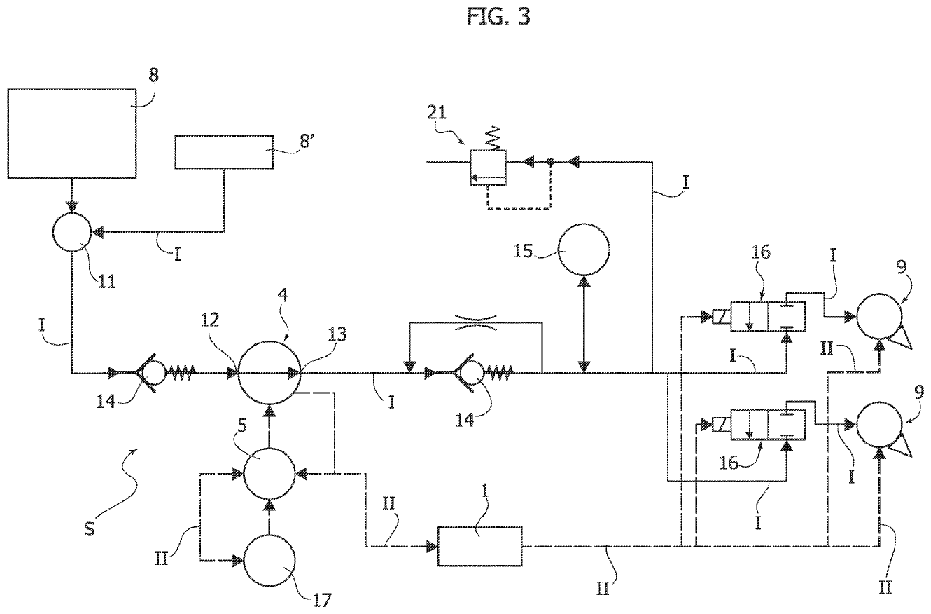

According to the embodiment shown in FIG. 3, the system S comprises a pumping unit 4, configured to generate the operating pressure of the jet of fluid directed onto the road surface by the injector means 9. In FIG. 3, reference I denotes a plurality of hydraulic conduits, arranged to connect the various components, while reference II indicates the logic functional connections among the components of system S. Preferably, the jet of fluid injected by the injector means 9 is withdrawn from the tank of the windscreen washing liquid 8 of the motor-vehicle V. Reference 8′ denotes an auxiliary tank containing an auxiliary liquid, preferably a defoaming liquid. A mixing unit 11 is hydraulically connected to the tank 8 and to the auxiliary tank 8′. The feeding of fluid is ensured by a pumping unit 4, including an intake port 12 and a delivery port 13. Still referring to the schematic view of FIG. 2, it may be observed that the comprises an electric motor 5. The pumping unit 4 pumping unit 4 moreover comprises a braking device 17, which is associated to the electric motor 5 and is arranged to block the operation of the pumping unit 4 during a stand-by condition of the system S, wherein the emission of the jet of fluid is not required. Always referring to FIG. 3, references 14 indicate two non-return valves, respectively arranged upstream the intake port 12 and downstream the delivery port 13. Upstream each injector 9 there is arranged a respective solenoid valve 16, configured to selectively enable a passage of fluid, so as to provide the emission of the jet of fluid. The system S may moreover comprise a safety valve 21, arranged to control and limit the pressure of the circuit. The system S may moreover comprise an accumulator 15, provided to keep the whole circuit under pressure and to avoid the need of installing a damping spring within pumping unit 4, so as to reduce the weight of the pumping unit 4 and the mechanical complexity thereof. The control unit 1 may be configured to control the injector means 9 and the electric motor 5, so as to generate, by means of the pumping unit 4, a jet of fluid which depends on the detected conditions. As mentioned in the foregoing, if the output signal exceeds a predetermined value corresponding to a high risk condition, the electronic control unit 1 is configured to start the activation of said further components of system S, by pressurizing the hydraulic circuit associated to the pumping unit 4 and/or by generating the jet of fluid onto the wet road surface.

As will be apparent from the description in the foregoing, the system S according to the invention is adapted to achieve the following advantages:
reliably acting prior to the contact of the tires of the motor vehicle with a water layer extended in such a quantity as to generate a phenomenon of aquaplaning,
avoiding an excessive impact on the overall weight of the motor-vehicle and on the development costs,
easy adaptability to different motor-vehicle architectures.

Of course, without prejudice to the principle of the invention, the implementation details and the embodiments may amply vary with respect to what has been described and illustrated, without departing from the extent of the invention as defined by the annexed claims.

1. An anti-aquaplaning system for motor-vehicles comprising:
a data transmission and receiving unit connectable to a cellular telephone network infrastructure, provided to transmit and receive a plurality of information,
at least one automated driving assistance device, provided to detect the dynamic conditions of the motor-vehicle and/or an environment in which the motor-vehicle is located, in order to assist a driver for different driving functions and increase a safety level,
an electronic control unit configured to assist the driver to avoid an aquaplaning phenomenon, the electronic control unit being programmed for:
receiving in real time a plurality of signals detected by means of the at least one automated driving assistance devices and the data transmission and receiving unit,
integrating the plurality of signals to generate an output signal indicative of a risk of aquaplaning,
if said output signal exceeds a predetermined value corresponding to a minimum risk condition, generating a warning for the driver so as to inform preventively of a risk of bumping into a water layer which could lead to a lifting and/or slipping condition of wheels of the motor-vehicle on a wet road surface,
in such a way that said electronic control unit is configured to alert the driver prior to a contact of the wheels with the water layer extended on the road surface in such quantity as to no longer ensure an adequate grip between the wheels of the motor-vehicle and the road surface.

2. The system according to claim 1, wherein said data transmission and receiving unit is configured to communicate with the cellular telephone network infrastructure, so as to:
transmit the plurality of information to a central server and/or to other vehicles located on a same road network, and
receive a plurality of information from said central server and from other vehicles located on the same road network.

3. The system according to claim 1, wherein said electronic control unit is programmed to reduce a speed of the motor-vehicle, if said output signal exceeds a predetermined value corresponding to an intermediate risk condition.

4. The system according to claim 1, wherein the data transmission and receiving unit is connected to the cellular telephone network infrastructure, to transmit and/or receive data relating to local weather conditions of an area where the motor-vehicle is located.

5. The system according to claim 2, wherein the data transmission and receiving unit is connected to the cellular telephone network infrastructure, to receive data relating to road surface conditions, from mapped information available in the central server or from detections by systems installed on other vehicles which have passed through a same area where the motor-vehicle is located.

6. The system according to claim 1, wherein the data transmission and receiving unit is connected to the cellular telephone network infrastructure, to transmit a notification of intervention occurred by electronic stability control systems mounted onboard the motor-vehicle and/or receive said notification from other vehicles passing through a same area where the motor-vehicle is located.

7. The system according to claim 2, wherein the data transmission and receiving unit is connected to the cellular telephone network infrastructure, to receive data relating to a dangerousness of a route of interest, through accidents statistics available on the central server.

8. The system according to claim 1, wherein said at least one automated driving assistance devices comprises a camera applicable on a windshield of the motor-vehicle, arranged to record events that occur outside the motor-vehicle in a direction in which the camera is directed.

9. The system according to claim 1, wherein said at least one automated driving assistance devices comprises a detection device configured to emit and receive electromagnetic waves, in order to scan and detect a position of objects outside the motor-vehicle.

10. The system according to claim 1, comprising one or more sensorized wheels, provided to detect and transmit information relating to the road surface and forces exchanged between the wheels and the road surface, said electronic control unit being programmed to receive in real time and process a plurality of signals detected by said sensorized wheels.

11. The system according to claim 1, comprising:
injector means associated to at least one wheel of the wheels of the motor-vehicle, provided for generating a high-pressure jet of fluid directed onto the road surface, so as to remove the water layer extending on that road surface,
a pumping unit operatively connected to said injector means, configured to generate operating pressure of the high-pressure jet of fluid,
wherein said electronic control unit is programmed to drive said pumping unit and said injector means, so as to generate an anti-aquaplaning action reactively, when the vehicle is already on the water layer presenting the risk of aquaplaning.

12. The system according to claim 11, wherein said electronic control unit is configured to pressurize a hydraulic circuit associated with said pumping unit and/or generating said high-pressure jet of fluid, if said output signal exceeds a predetermined value corresponding to a condition of high risk.

13. A method for avoiding an aquaplaning phenomenon in a motor-vehicle, comprising:
providing a system according to claim 1,
receiving in real time the plurality of signals detected by said at least one automated driving assistance devices and said data transmission and receiving unit,
integrating said signals to generate the output signal indicative of the risk of aquaplaning,
comparing said output signal with a risk scale indicative of the risk of aquaplaning based on multiple combinations of different parameters detectable by said at least one automated driver assistance devices and said data transmission and receiving unit,
if said output signal exceeds the predetermined value corresponding to the minimum risk condition, generating the warning for the driver so as to inform preventively of the risk of bumping into the water layer which could lead to a lifting and/or slipping condition of the wheels on the wet road surface,
in such a way that said electronic control unit is configured to alert the driver prior to the contact of the vehicle wheels with the water layer extended on the road surface in such quantity as to no longer ensure the adequate grip between the wheels of the motor-vehicle and the road surface.

14. The method according to claim 13, comprising:
providing injector means associated to at least one wheel of the wheels of the motor-vehicle, provided for generating a high-pressure jet of fluid directed onto the wet road surface, so as to remove the water layer extending on that road surface,
providing a pumping unit operatively connected to said injector means, configured to generate the operating pressure of the high-pressure jet of fluid, and
driving said pumping unit and said injector means by means of said electronic control unit, so as to generate an anti-aquaplaning action.
